(19) United States
(12) Patent Application Publication
(10) Pub. No.: US 2011/0195013 A1
(43) Pub. Date: Aug. 11, 2011

(54) Supported Catalyst for Synthesizing Carbon Nanotubes, Method for Preparing the Same and Carbon Nanotubes Made Using the Same

(75) Inventors: Seung Yong BAE, Uiwang-si (KR); Byeong Yeol KIM, Uiwang-si (KR); Yun Tack LEE, Uiwang-si (KR); Young Kyu CHANG, Uiwang-si (KR); Young Sil LEE, Uiwang-si (KR)

(73) Assignee: CHEIL INDUSTRIES INC., Gumi-si (KR)

(21) Appl. No.: 13/087,523

(22) Filed: Apr. 15, 2011

Related U.S. Application Data
(63) Continuation-in-part of application No. PCT/KR2008/007789, filed on Dec. 30, 2008.

(30) Foreign Application Priority Data
Oct. 17, 2008 (KR) 10-2008-0101906

(51) Int. Cl. D01F 9/127; B01J 21/04; B01J 21/10; B01J 21/08; B01J 35/10; B01J 35/08; B01J 37/08; B01J 23/745; B01J 23/755; B01J 23/75; D01F 9/12; B82Y 40/00

(52) U.S. Cl. 423/447.3; 502/332; 502/335; 502/336; 502/328; 502/260; 502/259; 502/258; 502/314; 502/306; 502/255; 502/300; 502/338; 502/337; 502/325; 502/355; 502/340; 502/240; 423/447.1; 977/842

(57) ABSTRACT

The present invention provides a supported catalyst for synthesizing carbon nanotubes. The supported catalyst includes a metal catalyst supported on a supporting body, and the supported catalyst has a surface area of about 15 to about 100 m²/g. The supported catalyst for synthesizing carbon nanotubes according to the present invention can lower production costs by increasing surface area of a catalytic metal to thereby allow production of a large amount of carbon nanotubes using a small amount of the catalyst.

### CROSS-REFERENCE TO RELATED APPLICATIONS

This application is a continuation-in-part of International Application No. PCT/KR2008/007789, filed Dec. 30, 2008, pending, which designates the U.S., published as WO 2010/044513, and is incorporated herein by reference in its entirety, and claims priority therefrom under 35 USC Section 120. This application also claims priority under 35 USC Section 119 from Korean Patent Application No. 10-2008-0101906, filed Oct. 17, 2008, in the Korean Intellectual Property Office, the entire disclosure of which is also incorporated herein by reference.

### FIELD OF THE INVENTION

The present invention relates to supported catalysts for synthesizing carbon nanotubes, a method of preparing the same, and carbon nanotubes manufactured using the same.

### BACKGROUND OF THE INVENTION

Carbon nanotubes are graphite layers rolled into cylindrical forms. Carbon nanotubes are widely used in various devices such as electron emitting devices, electronic devices, sensors, and the like due to their excellent electrical properties. Additionally, the carbon nanotubes can be used in other diverse applications such as high strength composite materials and the like due to their excellent physical properties.

Carbon nanotubes are classified as single-walled carbon nanotubes, double-walled carbon nanotubes and multi-walled carbon nanotubes, depending on the number of rolled surfaces of the cylinder form. The properties of carbon nanotubes can vary, depending at least in part on the number of such walls.

Composite materials using carbon nanotubes have been the subject of recent research and development activity. For example, engineering plastic composites including carbon nanotubes can have good electrical conductivity and thus can be useful in various electric and electronic articles. Accordingly, engineering plastic composites including carbon nanotubes can be used as high-value added materials including electro-magnetic shielding materials and antistatic materials.

Carbon nanotubes, however, are generally expensive. Accordingly, there is a need for inexpensive synthesis techniques for the manufacture of large quantities of carbon nanotubes for use in various fields.

Electrical conductivity exhibited by small amounts of carbon nanotubes can be significantly influenced by properties of the carbon nanotubes themselves as well as properties and processing conditions of resins. Therefore, there is also a need for high purity carbon nanotubes that can be synthesized at high productivity levels, as well as for catalysts used to synthesize such high purity carbon nanotubes at high productivity levels.

In general, methods for synthesizing carbon nanotubes include electric discharge methods, laser vaporizations, high pressure chemical vapor deposition, atmospheric pressure thermal chemical vapor deposition, and the like. Electric discharge and laser vaporization methods are relatively simple and easily used. Carbon nanotubes produced using electric discharge and laser vaporization, however, can include large amounts of impurities and are not suitable for mass production. In contrast, thermal chemical vapor deposition can be suitable for synthesizing large amounts of high purity carbon nanotubes at low cost.

When synthesizing carbon nanotubes using thermal chemical vapor deposition, a catalyst plays a very important role since the growth of the carbon nanotubes varies according to, for example, the types and composition ratios of transition metals and sizes of metal particles. Fe, Co, Ni and the like are used as the transition metals, and the transition metals are supported onto a supporting body to synthesize the carbon nanotubes.

One method for synthesizing catalysts for the production of carbon nanotubes is a co-precipitation method for supporting a pH-adjusted solution onto a supporting body. This method includes uniformly dissolving catalytic material into an aqueous solution and then adjusting the pH of the dissolved solution. Another method for synthesizing catalysts for the production of carbon nanotubes is an impregnation method. This method includes uniformly dissolving catalytic material into an aqueous solution, drying the dissolved solution through a drying process to form a dried material for uniformly supporting a metal catalyst, polishing the dried material, and then sintering the polished material at a high temperature of about 700° C. to about 900° C. for about 6 to about 10 hours. However, such methods are not suitable for mass production due to their long synthesis times and low yields.

In order to improve catalytic efficiency, it can be important to increase the surface area of the catalyst. Conventionally, mechanical and physical methods including grinding and ball milling have been used to increase the surface area of a catalyst. However, mechanical and physical methods such as grinding and ball milling can require additional equipment and/or processing steps and can increase costs and time. Further, it can be difficult to prepare very small catalysts using mechanical and physical methods such as grinding and ball milling.

Further, synthesizing high purity carbon nanotubes to improve physical and electrical properties of carbon nanotubes can require a purification process such as acid treatment or heat treatment. Such a post-treatment process, however, can increase production cost and surface defects of the carbon nanotubes, which can deteriorate inherent physical properties of the carbon nanotubes. Accordingly, there is a need for a technique for synthesizing large amounts of high purity carbon nanotubes without requiring a purification process.

### SUMMARY OF THE INVENTION

Therefore, in order to solve the aforementioned problems, the present inventors have developed a supported catalyst for synthesizing carbon nanotubes. The supported catalyst of the invention can have increased surface area and can allow the production of large amounts of high purity carbon nanotubes. Further, the supported catalyst can allow carbon nanotubes to grow in at least two different directions from the supported catalyst. The supported catalyst of the invention can be useful in various methods and apparatus for the production of carbon nanotubes, such as fixed bed reactors, fluidized bed reactors, and the like.

The present invention also provides a method of making the supported catalyst. The method of the invention includes forming spherical catalytic particles having a particle size ranging from a few microns to tens of microns using a spray-drying method and then crushing the spherical particles by high temperature sintering to thereby substantially increase the surface area of the spherical particles. The method of the present invention can reduce time and costs and can provide effective mass production since a post-treatment process such as a grinding or ball-milling process or an additional purification process is not necessary.

The present invention also provides carbon nanotubes manufactured using the support catalysts of the invention. The carbon nanotubes can be efficiently produced and can exhibit good selectivity and high purity.

Hereinafter, the aforementioned and other objects of the present invention can be all accomplished by the present invention described in detail.

The supported catalyst of the invention includes one or more metal catalysts supported on a supporting body. The metal catalyst can include, for example, Co, Ni, Fe, an alloy thereof, or a combination thereof. The supporting body can include, for example, an alumina, magnesium oxide, or silica supporting body. The supported catalyst further can have a surface area of about 15 to about 100 m²/g, for example about 50 to about 100 m²/g. In one exemplary embodiment, the metal catalyst may be supported on opposing front and back surfaces of the supported catalyst. Therefore, carbon nanotubes can grow in more than one direction from both of the front and back sides of the supported catalyst.

In one exemplary embodiment of the present invention, the supported catalyst may have the following molar ratio:

(Co,Ni)Fe:Mo:(Mg,Si)Al=x:y:z

wherein 1≦x≦10, 0≦y≦5, and 2≦z≦70.

In one exemplary embodiment, the supported catalyst may have the following molar ratio:

Fe:Mo:Al=x:y:z

wherein 1≦x≦10, 0≦y≦5, and 2≦z≦70.

The method of the invention comprises the steps of spray-drying an aqueous catalytic solution including a mixture of a metal catalyst and a supporting body to prepare spherical catalytic particles; and crushing (also referred to herein as breaking or splitting) the spherical catalytic particles by sintering. Generally the spherical catalytic particles are hollow.

In one exemplary embodiment, the metal catalyst may comprise Fe(NO₃)₃, Ni(NO₃)₂, Co(NO₃)₂, Fe(OAc)₂, Ni(OAc)₂, Co(OAc)₂, or a combination thereof.

The supporting body may comprise aluminum nitrate, magnesium nitrate, silica, or a combination thereof.

The metal catalyst and the supporting body may be dissolved into water to form the aqueous catalytic solution.

The spray-drying may be performed at a temperature of about 200 to about 350° C. In another exemplary embodiment, the spray-drying may be performed at a temperature of about 250 to about 300° C. Also, the spray-drying may be performed at a disc rotating speed of about 5,000 to about 20,000 rpm and a solution injection rate of about 10 to about 100 ml/min.

The sintering may be carried out at a temperature of about 350 to about 1,100° C.

A supported catalyst prepared by the method has an irregular shape resulting from crushing the hollow spherical particles during the sintering step.

The present invention further provides carbon nanotubes prepared using the supported catalyst and methods of making carbon nanotubes. The carbon nanotubes can grow in more than one direction, for example, from both sides including front and back sides of the supported catalyst.

The carbon nanotubes may be prepared in a fixed bed reactor or a fluidized bed reactor. In an exemplary embodiment, the carbon nanotube may be prepared by injecting hydrocarbon gases at a temperature of about 600 to about 1,100° C. in the presence of the supported catalyst.

### BRIEF DESCRIPTION OF THE DRAWINGS

FIG. 1 is a schematic view of a supported catalyst for synthesizing carbon nanotubes according to the present invention.

FIG. 2 is a schematic view showing a shape in which carbon nanotubes are grown in one direction of a supported catalyst.

FIG. 3 is a schematic view showing a shape in which the carbon nanotubes are grown in both directions of the supported catalyst according to the present invention.

FIG. 4 (a) is a Scanning Electron Microscopic (SEM) image of particles spray-dried in Example 1, and FIG. 4 (b) is an SEM image of a supported catalyst prepared according to Example 1.

FIG. 5 is an SEM image showing a shape of carbon nanotubes prepared according to Example 1.

FIG. 6 (a) is an SEM image of a supported catalyst prepared according to Comparative Example 1, and FIG. 6 (b) is an SEM image of a supported catalyst prepared according to Comparative Example 2.

FIG. 7 is a graph showing a relationship between surface areas of catalytic particles and productivities of carbon nanotubes.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Supported Catalyst

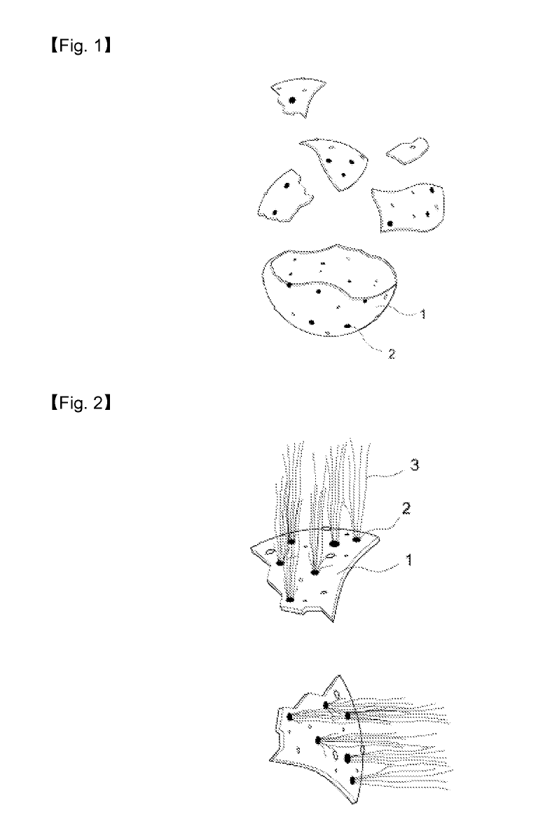

The present invention provides a supported catalyst for synthesizing carbon nanotubes. FIG. 1 is a schematic view of a supported catalyst for synthesizing carbon nanotubes according to the present invention. The supported catalyst includes a metal catalyst 2 supported on a supporting body 1, for example in the form of a plurality of metal catalyst particles 2 as illustrated distributed across a surface of the supporting body.

The supported catalyst has an irregular shape such as formed by crushing or breaking hollow spherical particles. Examples of the shape of the supported catalyst can include, but are not limited to, semicircular, sectorial, fragmental, planar, and crescent shapes.

In addition, as also illustrated in FIG. 1, pores may be formed on the surface of the supporting body 1. Further, the surface of a supported catalyst of the present invention may be curved or have protrusions formed thereon.

Also, the metal catalyst 2 is distributed on both sides including front and back sides (opposing front and back surfaces) of the supported catalyst. As used herein, reference to the front and back sides of the supported catalyst includes a first face with the metal catalyst present thereon and a second face opposite the first face, wherein the first and second faces correspond to an outer surface and an inner surface (or an inner surface and an outer surface) of hollow spherical particles before they are crushed. Since metal particles are present on the front and back sides of the supported catalyst of the present invention, carbon nanotubes may be grown on both sides including the front and back sides of the supported catalyst. This can allow the growth of carbon nanotubes with excellent purity and productivity.

The surface area of the supported catalyst measured using BET (Brunauer-Emmett-Teller) can be about 15 to about 100 m²/g, for example about 40 to about 100 m²/g. In other exemplary embodiments, the surface area of the supported catalyst can be about 50 to about 100 m²/g, for example about 60 to about 100 m²/g, as another example about 70 to about 100 m²/g, as another example about 80 to about 100 m²/g, and as yet another example about 90 to about 100 m²/g. In some embodiments, the surface area of the supported catalyst can be about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 m²/g. Further, according to some embodiments of the present invention, the surface area of the supported catalyst can be in a range from about any of the foregoing amounts to about any other of the foregoing amounts.

The supported catalyst can be naturally crushed by sintering (baking), which can provide a wide particle-size distribution. In an exemplary embodiment, the supported catalyst may have a diameter in the longest length thereof of about 0.01 to about 200 μm, for example about 0.1 to about 100 μm. In some embodiments, the supported catalyst may have a diameter in the longest length thereof of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200 μm. Further, according to some embodiments of the present invention, the supported catalyst may have a diameter in the longest length thereof of from about any of the foregoing amounts to about any other of the foregoing amounts.

Co, Ni, Fe, and the like, and alloys thereof, and combinations thereof may be used as the metal catalyst. Alumina, magnesium oxide, silica, and the like, and combinations thereof may be used as the supporting body.

In one exemplary embodiment of the present invention, the supported catalyst may have the following molar ratio:

(Co,Ni)Fe:Mo:(Mg,Si)Al=x:y:z

wherein 1≦x≦10, 0≦y≦5, and 2≦z≦70.

In exemplary embodiments, the supported catalyst may have the following molar ratio:

Fe:Mo:Al=x:y:z

wherein 1≦x≦10, 0≦y≦5, and 2≦z≦70.

Method of Making the Supported Catalyst

The present invention further provides a method of preparing the supported catalyst. The method comprises the steps of spray-drying an aqueous catalytic solution, in which a metal catalyst and a supporting body are mixed, to prepare spherical catalytic particles, and crushing the spherical catalytic particles by sintering.

Exemplary metal catalysts may include without limitation Fe(NO₃)₃, Ni(NO₃)₂, Co(NO₃)₂, Fe(OAc)₂, Ni(OAc)₂, Co(OAc)₂, and the like and mixtures of two or more thereof. In an exemplary embodiment, the metal catalyst may be in the form of a metal hydrate. For example, the metal catalyst may be used in the form of iron (III) nitrate nonahydrate, nickel (II) nitrate hexahydrate, cobalt nitrate hexahydrate, or a combination thereof.

Examples of the supporting body may include, but are not limited to, aluminum nitrate, magnesium nitrate, and the like, and mixtures of two or more thereof. In an exemplary embodiment, aluminum nitrate nonahydrate may be used as the supporting body.

The metal catalyst and supporting body can be dissolved into water and mixed to form the aqueous catalytic solution.

In another exemplary embodiment of the present invention, the aqueous catalytic solution can further include an activator. As a non-limiting example, a molybdenum (Mo) based activator such as ammonium molybdate tetrahydrate can be injected into water to prevent agglomeration of nano-sized metal catalysts during a sintering process at high temperatures. In another exemplary embodiment, an activator such as citric acid may also be used.

The metal catalyst and supporting body, and optionally the molybdenum (Mo) based or other activator, can be mixed and completely dissolved in the aqueous catalytic solution.

The aqueous catalytic solution including the metal catalyst and supporting body is prepared in the form of spherical particles, which are typically hollow, by a spray-drying method. Large amounts of a metal supporting body with uniform spherical shape and size can be relatively easily produced using spray-drying. The spray-drying method allows the supplied material to be dried almost instantaneously by spraying a supplied material in a fluid state into dry gas. The supplied material is dried very fast since the supplied material is atomized by an atomizer to result in a considerable increase of the surface area of the supplied material. In an exemplary embodiment, the spray-drying method may be performed at a temperature of about 200 to about 350° C., for example about 250 to about 300° C.

Exemplary spray-drying methods include without limitation methods using a nozzle and methods of spraying drops of water after forming drops of water according to the rotation of the disc. In exemplary embodiments, a disc type spray-drying method can be used to prepare a supported catalytic powder with a more uniform size. The disc type spray-drying method can include a vane or pin type spray-drying method.

Spray-drying equipment can have an effect on the size of a catalytic powder formed, for example, based on the density and spray amount of a solution and a rotating speed of an atomizer disc. Particle size and distribution, for example, may be controlled based on rotating speed of the disc and injection quantity and density of the solution. In an exemplary embodiment of the present invention, the spray-drying method may be carried out at a disc rotating speed of about 5,000 to about 20,000 rpm and a solution injection rate of about 10 to about 100 ml/min. In another exemplary embodiment, the disc rotating speed may be about 10,000 to about 18,000 rpm, about 12,000 to about 19,000 rpm, or about 5,000 to about 9,000 rpm. Further, the spray-drying method may be performed at a solution injection rate of about 15 to about 60 ml/min, about 50 to about 75 ml/min, or about 80 to about 100 ml/min.

In some embodiments, the spray-drying method may be carried out at a disc rotating speed of about 5000, 6000, 7000, 8000, 9000, 10,000, 11,000, 12,000, 13,000, 14,000, 15,000, 16,000, 17,000, 18,000, 19,000, or 20,000 rpm. Further, according to some embodiments of the present invention, the spray-drying method may be carried out at a disc rotating speed of about any of the foregoing speeds to about any other of the foregoing speeds.

In some embodiments, the spray-drying method may be carried out at a solution injection rate of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 ml/min. Further, according to some embodiments of the present invention, the spray-drying method may be carried out at a solution injection rate of about any of the foregoing rates to about any other of the foregoing rates.

A catalytic powder prepared through a spray-drying method can be heat-treated through a sintering process. The catalytic powder can be crystallized into a supported catalyst, and disintegration of the catalytic powder into spherical particles can occur through such a sintering process. Therefore, the catalytic powder can be split into randomly-sized and shaped particles with small sizes (for example into particles of varying sizes and shapes, typically irregular shapes) to increase the surface area of the catalytic powder.

Diameters and properties of carbon nanotubes can vary according to sintering temperature and length of the sintering process used to split the catalytic powder. In an exemplary embodiment, the sintering process may be performed at a temperature of about 350 to about 1100° C., for example about 450 to about 900° C., and as another example about 500 to about 800° C. Also, the sintering process may be performed at a temperature of about 350 to about 500° C., at about 550 to about 700° C., at about 650 to about 900° C., or at about 750 to about 1100° C. The sintering process may be carried out for about 15 minutes to about 3 hours, for example about 30 minutes to 1 hour. When the catalytic powder is subjected to such a sintering process, hollow spherical particles prepared by spray-drying are broken. Therefore, a supported catalyst prepared by the aforementioned method can have an irregular shape resulting from crushing or breaking the hollow spherical particles.

Further, the particles formed after the spray-drying process and before the sintering process can be hollow spherical particles having a metal catalyst present on outer and inner surfaces thereof. Crushing or breaking the hollow spherical particles by the sintering process thereby prepares a supported catalyst having the metal catalyst 2 of FIG. 1 distributed on both the front and rear sides thereof.

Carbon Nanotubes

The present invention further provides carbon nanotubes prepared using the aforementioned supported catalyst and methods of making the same. In an exemplary embodiment, the carbon nanotubes may be prepared by directing a carbon nanotube precursor material through a reactor including the supported catalyst of the invention under conditions sufficient to prepare carbon nanotubes. For example, the carbon nanotubes can be prepared by injecting a hydrocarbon gas in the presence of the supported catalyst at a temperature of about 600 to about 1100° C., for example about 650 to about 950° C. In one exemplary embodiment, carbon nanotubes may be prepared at a temperature of about 650 to about 800° C. In another exemplary embodiment, carbon nanotubes may be prepared at a temperature of about 800 to about 990° C. In another exemplary embodiment, carbon nanotubes may be prepared at a temperature of about 980 to about 1100° C. Examples of the hydrocarbon gas include, but are not limited to, methane, ethylene, acetylene, LPG (Liquefied Petroleum Gas), and mixtures thereof. The hydrocarbon gas can be supplied for about 15 minutes to about 2 hours, for example about 30 to about 60 minutes. The supported catalyst of the present invention may be used in any suitable reactor known in the art, such as but not limited to a fixed bed reactor or a fluidized bed reactor.

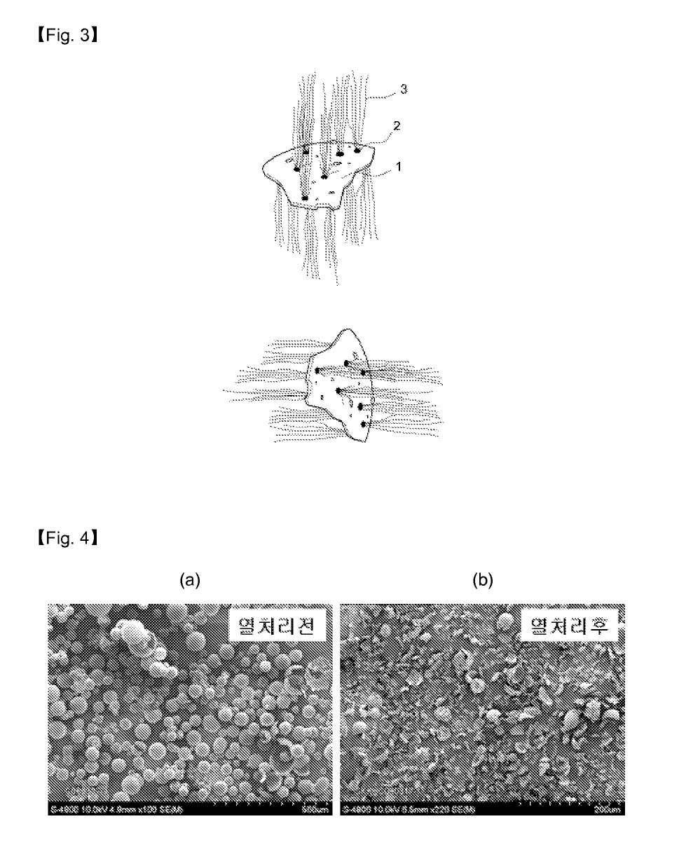

Carbon nanotubes prepared using a supported catalyst of the present invention can be grown in more than one direction, for example in at least two directions, one direction from the front sides of the supported catalysts and the other from the rear sides of the supported catalysts. FIG. 2 is a schematic view showing a shape in which carbon nanotubes 3 are grown in one direction of a conventional supported catalyst. Since a metal catalyst 2 is generally present only on one side of a conventional supported catalyst prepared by a conventional combustion method, the carbon nanotubes are grown only in one direction when preparing carbon nanotubes using the conventional supported catalyst. However, in the supported catalyst according to the present invention, since a metal catalyst is present on both sides including front and rear sides of the supported catalyst, the carbon nanotubes are capable of being grown in both directions when preparing carbon nanotubes using the supported catalyst of the invention. FIG. 3 is a schematic view showing carbon nanotubes 3 grown in both directions of the supported catalyst according to the present invention. As illustrated in FIG. 3, it can be seen that the carbon nanotubes 3 are grown in both directions since the metal catalyst 2 is present on both sides including front and rear sides of the supported catalyst.

The productivity of carbon nanotubes prepared using a supported catalyst of the present invention [(weight of synthesized carbon nanotubes—catalyst weight)/catalyst weight×100] can be about 5000% or more, for example about 7000% or more, and as another example about 9000% or more. In an exemplary embodiment, the carbon nanotubes according to the present invention can have a productivity of about 9010 to about 15000%.

The present invention will be well understood by the following examples. The following examples of the present invention are only for illustrative purposes and are not to be construed as limiting the scope of the present invention defined by the appended claims.

### Example 1

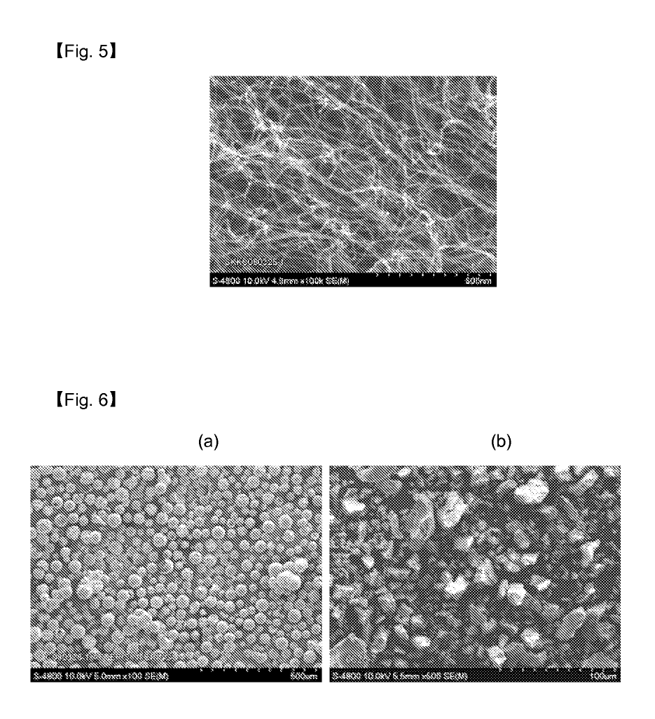

Spherical catalytic particles are prepared by injecting an aqueous catalytic solution comprising Fe, Co, Mo and Al₂O₃ (a molar ratio of Fe:Co:Mo:Al=2:3:1:12) into a spray-dryer (Niro Spray-dryer Mobile Minor™) and simultaneously spraying and drying the aqueous catalytic solution using hot air at a temperature of about 290° C. An SEM image of one hundred magnification showing catalytic particles prepared at a disc rotating speed of 5,000 to 20,000 rpm and a solution injection rate of 10 to 100 ml/min is illustrated in FIG. 4 (a).

A supported catalyst is synthesized by sintering the prepared catalytic powder at a temperature of about 550° C. for 30 minutes under normal pressure and air atmosphere. An SEM image of the prepared supported catalyst is illustrated in FIG. 4 (b). FIG. 4 (b) demonstrates that the spherical catalytic particles are randomly broken into small-sized particles after the sintering process. The surface area of the prepared catalyst is measured using BET.

Carbon nanotubes are synthesized for 45 minutes while 0.01 g of the supported catalyst synthesized by the aforementioned method flowed in a fixed-bed thermal chemical vapor deposition system at a temperature of about 700° C. at a flow rate of 100/100 sccm of ethylene and hydrogen at a ratio of 1:1. An SEM image of the synthesized carbon nanotubes is photographed at 100,000 magnification and illustrated in FIG. 5. The carbon purity of the synthesized carbon nanotubes is measured using TGA and the productivity is measured as an increased weight of the carbon nanotubes after the synthesis, and the results are shown in Table 1. The surface area of the catalyst is about 57 m²/g, up to about 90 g of the carbon nanotubes could be produced from about 1 g of the catalyst, and the carbon purity is 98.8%.

### Comparative Example 1

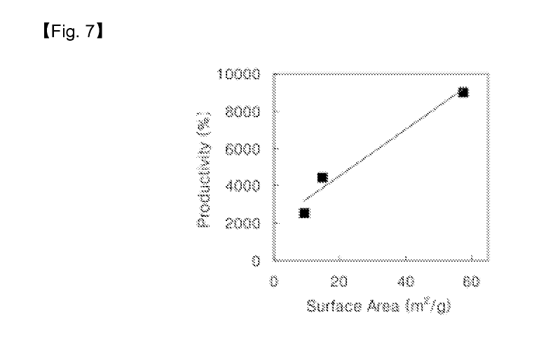

A supported catalyst is prepared in the same manner as in Example 1 except that a water-soluble polyvinylpyrrolidone (PVP) polymer is added to an aqueous catalytic solution at a ratio of 20% by weight with respect to the solid content. An SEM image of the prepared supported catalyst is illustrated in FIG. 6 (a). FIG. 6 (a) illustrates that spherical particles in the polymer-mixed aqueous catalytic solution are not broken, but maintain their spherical shape even after the sintering process. The surface area of the prepared catalyst is measured using BET, carbon nanotubes are synthesized under the same conditions as Example 1, and the purity and productivity of the carbon nanotubes are set forth in Table 1.

### Comparative Example 2

A supported catalyst is prepared in the same manner as in Example 1 except that an aqueous catalytic solution is directly subjected to the sintering process without performing the spray-drying process. An SEM image of the prepared supported catalyst is illustrated in FIG. 6 (b). FIG. 6 (b) illustrates that the prepared supported catalyst is formed in a random shape without having a specific shape, or a metal catalyst is formed only on one side of the supported catalyst. The surface area of the prepared catalyst is measured using BET, the carbon nanotubes are synthesized under the same conditions as Example 1, and the purity and productivity of the carbon nanotubes are set forth Table 1.

TABLE 1

| | | Comparative | Comparative |
|---|---|---|---|
| | Example 1 | Example 1 | Example 2 |
| Catalyst preparing | Spray-drying | Spray-drying | Combustion |
| method | | | method |
| Surface area of | 57.03 | 9.01 | 14.35 |
| supported catalyst | | | |
| (m²/g) | | | |
| Purity of carbon | 98.8 | 95.1 | 95.2 |
| nanotubes (%) | | | |
| Productivity of carbon | 9060 | 2600 | 4500 |
| nanotubes (%) | | | |

* Productivity of carbon nanotubes = (weight of synthesized carbon nanotubes − catalyst weight)/catalyst weight × 100

FIG. 7 is a graph showing the relationship between the surface area of the catalytic particles prepared according to Example 1 and Comparative Examples 1 and 2 and the productivity of the process used to prepare carbon nanotubes using the same. FIG. 7 demonstrates that the production efficiencies increase as the surface areas increase. This shows that the surface areas of the catalysts are closely related to the productivities of the carbon nanotubes. Further, it can be seen that it is important to increase the surface area of a catalytic metal in order to mass-produce high purity carbon nanotubes at low costs since the productivities of the carbon nanotubes are also related to the purities of the carbon nanotubes.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A supported catalyst for synthesizing carbon nanotubes, comprising:
a metal catalyst comprising Co, Ni, Fe, an alloy thereof, or a combination thereof supported on an alumina, magnesium oxide or silica supporting body, wherein the supported catalyst has a surface area of about 15 to about 100 m²/g.

2. The supported catalyst of claim 1, wherein the supported catalyst has a crushed spherical shape.

3. The supported catalyst of claim 1, comprising a surface area about 50 to about 100 m²/g.

4. The supported catalyst of claim 1, wherein the supporting body includes opposing front and back surfaces and wherein the metal catalyst is supported on both of the opposing surfaces of the supported catalyst.

5. The supported catalyst of claim 1, wherein the supported catalyst has the following molar ratio:
(Co,Ni)Fe:Mo:(Mg,Si)Al=x:y:z
wherein 1≦x≦10, 0≦y≦5, and 2≦z≦70.

6. The supported catalyst of claim 1, wherein the supported catalyst has the following molar ratio:
Fe:Mo:Al=x:y:z
wherein 1≦x≦10, 0≦y≦5, and 2≦z≦70.

7. A method of preparing a supported catalyst for synthesizing carbon nanotubes, comprising the steps of:
spray-drying an aqueous catalytic solution including a mixture of a metal catalyst and a supporting body to prepare spherical catalytic particles; and
crushing the spherical catalytic particles by sintering.

8. The method of claim 7, wherein the metal catalyst comprises Fe(NO₃)₃, Ni(NO₃)₂, Co(NO₃)₂, Fe(OAc)₂, Ni(OAc)₂, Co(OAc)₂, or a combination thereof.

9. The method of claim 7, wherein the supporting body comprises aluminum nitrate, magnesium nitrate, or silica.

10. The method of claim 7, wherein the metal catalyst and the supporting body are mixed in water to form the aqueous catalytic solution.

11. The method of claim 7, comprising spray-drying the aqueous catalytic solution at a temperature of about 200 to about 350° C.

12. The method of claim 11, comprising spray-drying the aqueous catalytic solution at a disc rotating speed of about 5,000 to about 20,000 rpm and a solution injection rate of about 10 to about 100 ml/min.

13. The method of claim 7, comprising sintering the spherical catalytic particles at a temperature of about 350 to about 1,100° C.

14. A method of making carbon nanotubes, comprising directing a carbon nanotube precursor material through a reactor including a supported catalyst of claim 1 under conditions sufficient to produce the carbon nanotubes.

15. The method of claim 14, wherein the supported catalyst of claim 1 comprises a metal catalyst supported on a supporting body, wherein the supporting body includes opposing front and back surfaces and wherein the metal catalyst is supported on both of the opposing surfaces of the supported catalyst so that the carbon nanotubes grow on both of the front and back surfaces of the supported catalyst.

16. The method of claim 14, wherein the reactor is a fixed bed reactor.

17. The method of claim 14, wherein the carbon nanotube precursor material comprises hydrocarbon gases and wherein the step of directing the carbon nanotube precursor material through a reactor comprises directing the hydrocarbon gases through the reactor at a temperature of about 600 to about 1,100° C. in the presence of the supported catalyst.
